(19) United States
(12) Patent Application Publication
(10) Pub. No.: US 2016/0341550 A1
(43) Pub. Date: Nov. 24, 2016

(54) ROTATION RATE SENSOR AND METHOD FOR OPERATING A ROTATION RATE SENSOR WITH CIRCULAR DRIVE

(71) Applicant: Robert Bosch GmbH, Stuttgart (DE)

(72) Inventors: Carsten GECKELER, Tuebingen (DE); Patrick Wellner, Walddorfhaeslach (DE)

(21) Appl. No.: 15/154,580

(22) Filed: May 13, 2016

(30) Foreign Application Priority Data
May 19, 2015 (DE) 102015209100.7

(51) Int. Cl. G01C 19/5712

(52) U.S. Cl. CPC G01C 19/5712

(57) ABSTRACT

A rotation rate sensor, comprising a substrate having a principal extension plane and comprising a first Coriolis element movable with respect to the substrate and comprising a first suspension means movably suspending the first Coriolis element relative to the substrate, is proposed; the rotation rate sensor having a first excitation means for driving the first Coriolis element in such a way that with the first excitation means activated, the first Coriolis element continuously exhibits motion states deflected with respect to a rest position, the velocity vector of the mass center point of the first Coriolis element having, in each of the deflected motion states, an absolute value from greater than or equal to 90% of a predefined target velocity to less than or equal to 110% of the predefined target velocity.

### CROSS REFERENCE

The present application claims the benefit under 35 U.S.C. §119 of German Patent Application No. DE 102015209100.7 filed on May 19, 2015, which is expressly incorporated herein by reference in its entirety.

### BACKGROUND INFORMATION

The present invention relates to micromechanical rotation rate sensors having a substrate and having a Coriolis element movable with respect to the substrate, and having a suspension means movably suspending the Coriolis element relative to the substrate, and having an excitation means for driving the Coriolis element so that with the excitation means activated, the Coriolis element oscillates linearly substantially in one direction and the absolute value of the speed of the Coriolis element changes cyclically over time.

Micromechanical rotation rate sensors are available. These rotation rate sensors usually encompass at least one Coriolis element that oscillates in a defined drive direction at a specific frequency and a specific amplitude.

In conventional rotation rate sensors, in order to enable the detection of rotation rates around different rotation axes, also called “multichannel” capability, several separate Coriolis elements, caused to oscillate linearly, are coupled to one another. Each Coriolis element is respectively responsible for detecting a rotation rate around one specific rotation axis. This means that for a multichannel rotation rate sensor, the substrate area required for the micromechanical structure increases in accordance with the number of rotation axes around which rotation rates are to be detected.

### SUMMARY

A rotation rate sensor according to an example embodiment of the present invention and a method according to an example embodiment of the present invention for operating a rotation rate may have the advantage that a multichannel rotation rate sensor is made possible on a substrate area that is small relative to the existing art, since for the micromechanical structure, a substrate area that is small relative to the existing art is all that is needed to detect rotation rates around several rotation axes. The use of several Coriolis elements, each for detection of a rotation rate around one rotation axis, is dispensed with here. Instead, rotation rates around up to three mutually perpendicularly extending rotation axes are detected in one substrate region. In addition, the number of springs and sub-regions is kept low as compared with conventional rotation rate sensors, among other reasons in order to correspondingly reduce the number of parasitic eigenmodes. This is achieved by the fact that the rotation rate sensor according to the present invention has a first excitation means for driving the first Coriolis element in such a way that with the first excitation means activated, the first Coriolis element continuously exhibits motion states deflected with respect to a rest position, the velocity vector of the mass center point of the first Coriolis element having, in each of the deflected motion states, an absolute value from greater than or equal to 90% of a predefined target velocity to less than or equal to 110% of the predefined target velocity. The rotation rate sensor according to the present invention has at least one first Coriolis element, i.e., both exemplifying embodiments or refinements having one Coriolis elements and ones having a plurality of Coriolis elements are possible, in particular ones having two Coriolis elements.

Advantageous embodiments and refinements of the present invention may be gathered from the description below with reference to the figures.

According to a preferred refinement, provision is made that the first Coriolis element is embodied as an annular first disk; the annular first disk extending substantially in a plane substantially parallel to the principal extension plane of the substrate; the rotation rate sensor having, in the region of the center point of the annular first disk, at least one substrate-mounted first anchor point; the annular first disk being connected to the first anchor point via a first suspension unit of the first suspension means; the rotation rate sensor having, in the radially outwardly directed region of the annular first disk, at least one substrate-mounted second anchor point; the annular first disk being connected to the second anchor point via a second suspension unit of the first suspension means; the excitation means being disposed in the radially outwardly directed region of the annular first disk; the first excitation means being disposed with respect to the annular first disk in such a way that with the first excitation means activated and with no application of a physical magnitude to be detected, each motion state, deflected with respect to the rest position, of the annular first disk encompasses a position of the mass center point of the annular first disk substantially in a plane parallel to the principal extension plane of the substrate. A multichannel rotation rate sensor that detects, on a substrate area that is small relative to the existing art, rotation rates around several rotation axes in one substrate region is thereby advantageously proposed.

According to a preferred refinement, provision is made that the first suspension unit and/or the second suspension unit respectively encompasses at least one spring, in particular a compression spring and/or a tension spring and/or a flexural spring and/or a torsional spring, the number of springs being greater than 2, in particular 3, 4, 5, 6, 7, 8, 9, 10. This advantageously makes it possible for the first Coriolis element to be suspended movably relative to the substrate. In particular, the first Coriolis element can thus advantageously be deflected into an excitation oscillation substantially along a substantially closed circular trajectory located substantially parallel to the principal extension plane, with respect to the rest state. A number of springs greater than 2 makes the rotational acceleration sensor particularly robust with respect to the detection of linear accelerations.

According to a preferred refinement, provision is made that the first excitation means has at least one first excitation unit; the first excitation unit being embodied as a capacitive comb structure; the number of first excitation units being greater than 2, in particular 3, 4, 5, 6, 7, 8, 9, 10. This advantageously makes it possible for the first Coriolis element to be excited into an excitation oscillation substantially along a substantially closed circular trajectory located substantially parallel to the principal extension plane, with respect to the rest state. A number of first excitation units greater than 2 advantageously makes it possible for the first Coriolis element or annular first disk to be excited into a motion along a circular trajectory.

According to a preferred refinement, provision is made that the rotation rate sensor encompasses a first detection means; the first detection means encompassing a first detection unit for detecting a deflected state of the Coriolis element in the sense of a deflection of the Coriolis element out of a plane parallel to the principal extension plane and containing, in the rest state, the mass center point of the Coriolis element, and in a direction parallel to a first axis substantially perpendicular to the principal extension plane as a result of a rotation rate of the rotation rate sensor around an axis parallel to a second axis substantially parallel to the principal extension plane and/or as a result of a rotation rate of the rotation rate sensor around an axis parallel to a third axis substantially parallel to the principal extension plane and perpendicular to the second axis; the first detection unit encompassing at least one first electrode; the first electrode being embodied in substantially plate-shaped fashion; the first electrode extending substantially parallel to the principal extension plane and being disposed at least in part between the substrate and the Coriolis element and/or being disposed on a side of the Coriolis element facing away from the substrate. This advantageously makes possible detection of a deflected state of the Coriolis element in the sense of a deflection of the Coriolis element out of a plane parallel to the principal extension plane and containing, in the rest state, the mass center point of the Coriolis element, and in a direction substantially parallel to a first axis substantially perpendicular to the principal extension plane. In addition, the fact that the first electrode is disposed at least in part between the substrate and the Coriolis element, and/or is disposed on a side of the Coriolis element facing away from the substrate, advantageously makes it possible for the detected signal to be further elevated, so that additional potential for area shrinkage can be furnished.

According to a preferred refinement, provision is made that the detection means encompasses a second detection unit for detecting a deflected state of the Coriolis element in the sense of a deflection of the Coriolis element along a plane parallel to the principal extension plane as a result of a rotation rate of the rotation rate sensor around an axis parallel to the first axis, the second detection unit encompassing at least one capacitive second electrode. This advantageously makes it possible for deflected states of the Coriolis element, in the sense of a deflection of the Coriolis element along a plane parallel to the principal extension plane, to be detected.

According to a preferred refinement, provision is made that the rotation rate sensor encompasses a second Coriolis element movable with respect to the substrate, and a second suspension means movably suspending the second Coriolis element relative to the substrate; the rotation rate sensor having a second excitation means for driving the second Coriolis element in such a way that with the second excitation means activated, the second Coriolis element continuously exhibits motion states deflected with respect to a rest position; the velocity vector of the mass center point of the second Coriolis element having, in each of the deflected motion states, an absolute value from greater than or equal to 90% of a predefined target velocity to less than or equal to 110% of the predefined target velocity; the rotation rate sensor having a coupling structure for coupling the second Coriolis element to the first Coriolis element in such a way that a motion of the first Coriolis element substantially clockwise around the first axis when looking onto the principal extension plane is possible; and that a motion of the second Coriolis element substantially counter-clockwise around an axis parallel to the first axis when looking onto the principal extension plane is possible. This advantageously makes it possible for the rotation rate sensor according to the present invention to be particularly robust against interference frequencies at the driving frequency.

According to a preferred refinement, provision is made that the coupling structure is connected to the substrate via a substrate-mounted third anchor point; the coupling structure being connected to the substrate via a substrate-mounted fourth anchor point; the coupling structure encompassing a coupling spring. A rotation rate sensor that is particularly robust against interference frequencies is thus advantageously furnished.

A further subject of the present invention is a method for operating a rotation rate sensor; the rotation rate sensor encompassing a substrate having a principal extension plane and encompassing a first Coriolis element movable with respect to the substrate, and a first suspension means movably suspending the first Coriolis element relative to the substrate, and a first excitation means; the first Coriolis element being excited with the aid of the first excitation means into an excitation oscillation substantially along a substantially closed circular trajectory located substantially parallel to the principal extension plane and substantially clockwise around a first axis when looking onto the principal extension plane, which causes the first Coriolis element to continuously exhibit motion states deflected with respect to a rest position; the velocity vector of the mass center point of the first Coriolis element having, in each of the deflected motion states, an absolute value from greater than or equal to 90% of a predefined target velocity to less than or equal to 110% of the predefined target velocity.

This advantageously makes it possible for rotation rates around one rotation axis and/or two mutually perpendicular rotation axes and/or three mutually perpendicular rotation axes to be detected, on a substrate area that is small relative to the existing art, in one substrate region.

According to a preferred refinement, provision is made that the rotation rate sensor encompasses a second Coriolis element movable with respect to the substrate, and a second suspension means movably suspending the second Coriolis element relative to the substrate, and a second excitation means; the second Coriolis element being excited with the aid of the second excitation means into an excitation oscillation substantially along a substantially closed circular trajectory located substantially parallel to the principal extension plane and substantially counter-clockwise around an axis parallel to the first axis when looking onto the principal extension plane, which causes the second Coriolis element to continuously exhibit motion states deflected with respect to a rest position; the velocity vector of the mass center point of the second Coriolis element having, in each of the deflected motion states, an absolute value from greater than or equal to 90% of a predefined target velocity to less than or equal to 110% of the predefined target velocity; a coupling structure coupling the second Coriolis element to the first Coriolis element. This advantageously makes it possible for rotation rates around one rotation axis and/or two mutually perpendicular rotation axes and/or three mutually perpendicular rotation axes to be detected, on a substrate area that is small relative to the existing art, in a manner that is robust with respect to interference frequencies.

### BRIEF DESCRIPTION OF THE DRAWINGS

FIG. 1 is a schematic depiction of a rotation rate sensor according to an exemplifying embodiment of the present invention.

FIG. 2 is a perspective view of the rotation rate sensor according to FIG. 1.

FIG. 3 schematically depicts the rotation rate sensor according to FIG. 1 and FIG. 2, including a first excitation means.

FIG. 4 schematically depicts a rotation rate sensor according to a further exemplifying embodiment of the present invention.

FIG. 5 is a sectioned view of the rotation rate sensor according to FIG. 4.

### DETAILED DESCRIPTION OF EXAMPLE EMBODIMENTS

In the various Figures, identical parts are labeled with identical reference characters and are therefore also, generally, each recited or mentioned only once.

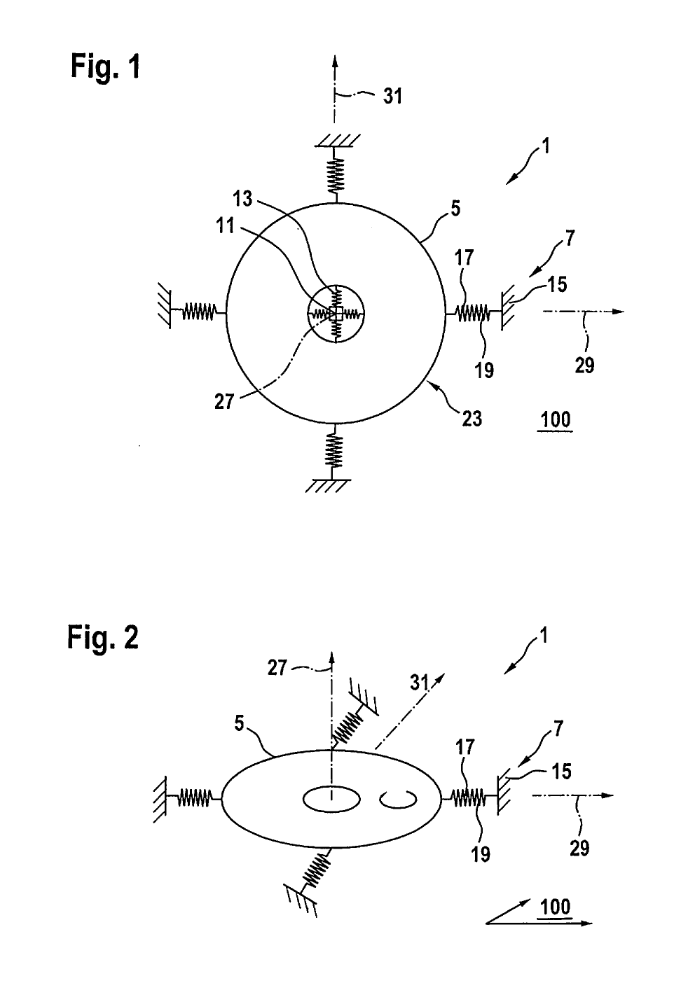

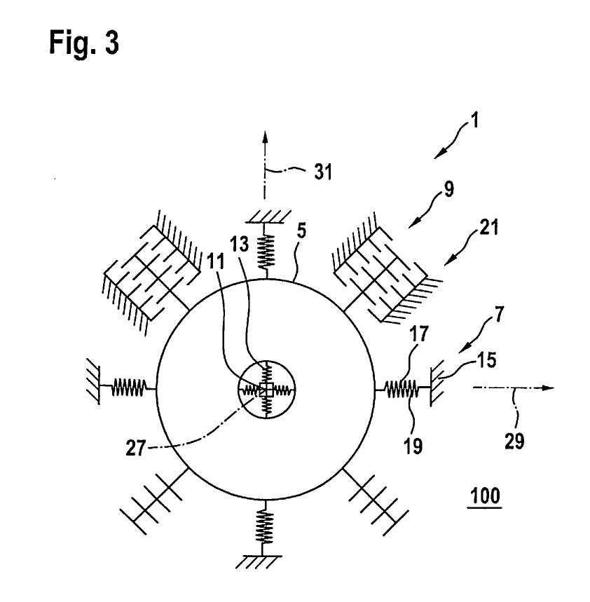

FIG. 1 schematically depicts a rotation rate sensor 1 according to an exemplifying embodiment of the present invention, rotation rate sensor 1 encompassing a substrate 3 (not depicted in FIG. 1) having a principal extension plane 100, a first Coriolis element 5, and a first suspension means 7. Rotation rate sensor 1 furthermore encompasses an excitation means 9, depicted in FIG. 3, for driving first Coriolis element 5.

In rotation rate sensor 1 depicted by way of example in FIG. 1, first Coriolis element 5 is embodied as an annular disk 5 that extends substantially in a plane substantially parallel to principal extension plane 100 of substrate 3. Shapes other than an annular disk are also possible, for example frame-like panels, circular panels, rectangular panels, or also shapes that preferably have a three-dimensional character.

Rotation rate sensor 1 depicted by way of example in FIG. 1 has, in the region of the center point of annular first disk 5, a substrate-mounted first anchor point 11. Annular first disk 5 is connected to first anchor point 11 via a first suspension unit 13 of first suspension means 7. The use of more than one first anchor point 11 is also possible. In rotation rate sensor 1 depicted in FIG. 1, first suspension unit 13 involves four springs 19, in particular four compression springs and/or four tension springs and/or four flexural springs and/or four torsional springs.

Rotation rate sensor 1 depicted in FIG. 1 furthermore has four substrate-mounted second anchor points 15 in the radially outwardly directed region of annular first disk 5. Annular first disk 5 is connected to second anchor point 15 via a second suspension unit 17 of first suspension means 7. Second suspension unit 17 encompasses four springs 19, in particular four compression springs and/or four tension springs and/or four flexural springs and/or four torsional springs.

A different number, greater than 2, of springs 19 of first suspension unit 13 and/or of second suspension unit 17 is also conceivable, in particular 3, 5, 6, 7, 8, 9, 10. The advantage of using more than two springs 19 is that with an increasing number of springs, rotation rate sensor 1 becomes more robust against linear accelerations in a plane parallel to the principal extension plane.

Rotation rate sensor 1 depicted in FIG. 1 furthermore encompasses, for example, a first detection means 23 (not depicted in FIG. 1). First detection means 23 encompasses, for example, a first detection unit (not depicted) for detecting a deflected state of Coriolis element 5 in the sense of a deflection of Coriolis element 5 out of a plane that also contains the rest state depicted in FIG. 1 and proceeds substantially out of and into the image plane of FIG. 1 and along a first axis 27 depicted in FIG. 2.

Detection means 23 furthermore preferably encompasses a second detection unit (not depicted) for detecting a deflected state of Coriolis element 5 in the sense of a deflection of Coriolis element 5 along a plane parallel to principal extension plane 100.

The first detection unit and/or the second detection unit preferably encompasses at least one piezoelectric and/or electromagnetic and/or capacitive element.

FIG. 3 schematically depicts rotation rate sensor 1 according to FIG. 1 and FIG. 2 including a first excitation means 9, excitation means 9 being disposed in the radially outwardly directed region of annular first disk 5. First excitation means 9 has four first excitation units 21. The four first excitation units 21 are embodied as capacitive comb structures. Excitation units 21 preferably encompass at least one magnetic and/or piezoelectric and/or electromagnetic and/or capacitive element. A different number, greater than 2, of first excitation units 21 is also conceivable, in particular 3, 4, 5, 6, 7, 8, 9, 10. The advantage of more than two excitation units is that with the aid of the more than two excitation units the Coriolis element is advantageously excited into an excitation oscillation substantially along a substantially closed circular trajectory located substantially parallel to principal extension plane 100. Increasing homogeneity of the excitation oscillation becomes possible with an increasing number of first excitation units 21.

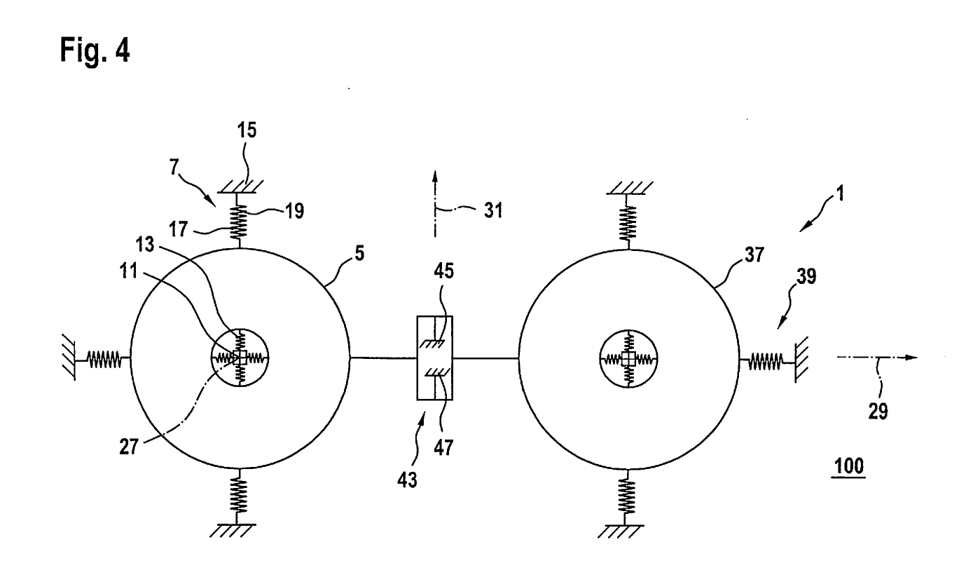

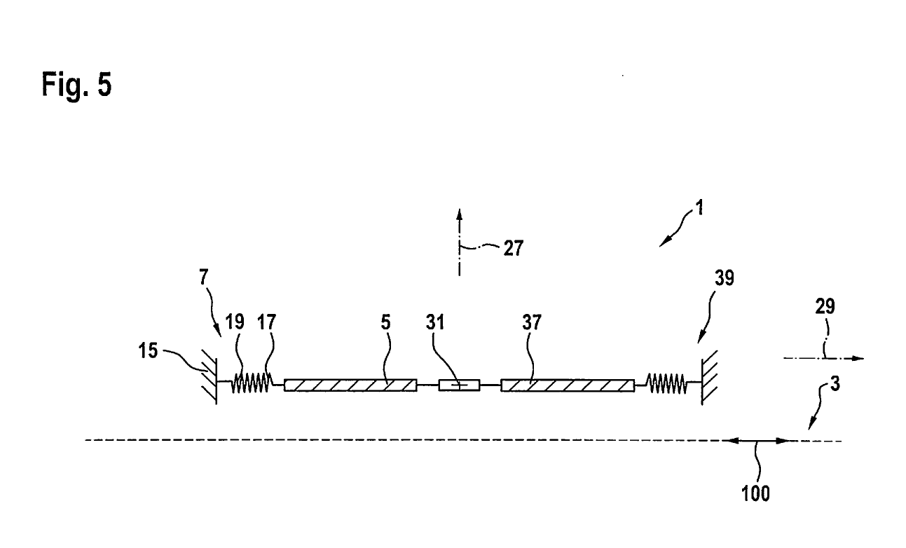

FIG. 4 and FIG. 5 depict a rotation rate sensor according to a further exemplifying embodiment of the present invention. The rotation rate sensor depicted in FIG. 4 and in FIG. 5 encompasses, in addition to first Coriolis element 5, a second Coriolis element 37 comparable to first Coriolis element 5 as well as second suspension means 39, second excitation means, and second detection means comparable with the first exemplifying embodiment.

What is claimed is:

1. A rotation rate sensor, comprising:
a substrate having a principal extension plane;
a first Coriolis element which is movable with respect to the substrate;
a first suspension element which movably suspends the first Coriolis element relative to the substrate; and
a first excitation element to drive the first Coriolis element in such a way that with the first excitation element activated, wherein the first Coriolis element continuously exhibits motion states deflected with respect to a rest position, and wherein a velocity vector of a mass center point of the first Coriolis element has, in each of the deflected motion states, has an absolute value from greater than or equal to 90% of a predefined target velocity to less than or equal to 110% of the predefined target velocity.

2. The rotation rate sensor as recited in claim 1, wherein:
the first Coriolis element is an annular first disk, the annular first disk extending substantially in a plane substantially parallel to the principal extension plane of the substrate;
the rotation rate sensor has, in a region of a center point of the annular first disk, at least one substrate-mounted first anchor point;
the annular first disk is connected to the first anchor point via a first suspension unit of the first suspension element;
the rotation rate sensor has, in a radially outwardly directed region of the annular first disk, at least one substrate-mounted second anchor point, the annular first disk being connected to the second anchor point via a second suspension unit of the first suspension element;
the excitation element is disposed in the radially outwardly directed region of the annular first disk;
the first excitation element is disposed with respect to the annular first disk in such a way that with the first excitation element activated and with no application of a physical magnitude to be detected, each motion state, deflected with respect to the rest position, of the annular first disk encompasses a position of the mass center point of the annular first disk substantially in a plane parallel to the principal extension plane of the substrate.

3. The rotation rate sensor as recited in claim 2, wherein at least one of the first suspension unit and the second suspension unit respectively include at least one spring, each of the at least one springs being at least one of a compression spring, a tension spring, a flexural spring, and a torsional spring, the number of springs being greater than 2.

4. The rotation rate sensor as recited in claim 1, wherein the first excitation element has at least one first excitation unit, the first excitation unit being embodied as a capacitive comb structure, and wherein the number of first excitation units is greater than 2.

5. The rotation rate sensor as recited in claim 1, further comprising:
a first detector including a first detection unit to detect a deflected state of the Coriolis element in the sense of a deflection of the Coriolis element out of a plane parallel to the principal extension plane and containing, in the rest state, a mass center point of the Coriolis element, and in a direction parallel to a first axis substantially perpendicular to the principal extension plane as a result of at least one of: i) a rotation rate of the rotation rate sensor around an axis parallel to a second axis substantially parallel to the principal extension plane, and ii) a rotation rate of the rotation rate sensor around an axis parallel to a third axis substantially parallel to the principal extension plane and perpendicular to the second axis;
wherein the first detection unit includes at least one first electrode, the first electrode being embodied in substantially plate-shaped fashion and extending substantially parallel to the principal extension plane, the first electrode being disposed at least one of: i) at least in part between the substrate and the Coriolis element, and ii) on a side of the Coriolis element facing away from the substrate.

6. The rotation rate sensor as recited in claim 1, wherein the first detector includes a second detection unit to detect a deflected state of the Coriolis element in the sense of a deflection of the Coriolis element along a plane parallel to the principal extension plane as a result of a rotation rate of the rotation rate sensor around an axis parallel to the first axis, the second detection unit encompassing at least one capacitive second electrode.

7. The rotation rate sensor as recited in claim 1, further comprising:
a second Coriolis element movable with respect to the substrate, and a second suspension element movably suspending the second Coriolis element relative to the substrate;
a second excitation element to drive the second Coriolis element in such a way that with the second excitation means activated, wherein the second Coriolis element continuously exhibits motion states deflected with respect to a rest position, wherein the velocity vector of a mass center point of the second Coriolis element has, in each of the deflected motion states, an absolute value from greater than or equal to 90% of a predefined target velocity to less than or equal to 110% of the predefined target velocity; and
a coupling structure to couple the second Coriolis element to the first Coriolis element in such a way that a motion of the first Coriolis element substantially clockwise around the first axis when looking onto the principal extension plane is possible, wherein a motion of the second Coriolis element is substantially counter-clockwise around an axis parallel to the first axis when looking onto the principal extension plane s possible.

8. The rotation rate sensor as recited in claim 7, wherein the coupling structure is connected to the substrate via a substrate-mounted third anchor point, the coupling structure being connected to the substrate via a substrate-mounted fourth anchor point, and coupling structure includes a coupling spring.

9. A method for operating a rotation rate sensor, the rotation rate sensor including a substrate having a principal extension plane, a first Coriolis element movable with respect to the substrate, a first suspension element movably suspending the first Coriolis element relative to the substrate, and a first excitation element, the method comprising:
exciting the first Coriolis element with the aid of the first excitation element into an excitation oscillation substantially along a substantially closed circular trajectory located substantially parallel to the principal extension plane and substantially clockwise around a first axis when looking onto the principal extension plane, to cause the first Coriolis element to continuously exhibit motion states deflected with respect to a rest position, the velocity vector of the mass center point of the first Coriolis element having, in each of the deflected motion states, an absolute value from greater than or equal to 90% of a predefined target velocity to less than or equal to 110% of the predefined target velocity.

10. The method as recited in claim 9, wherein the rotation rate sensor further includes a second Coriolis element movable with respect to the substrate, a second suspension element movably suspending the second Coriolis element relative to the substrate, and a second excitation element, the method further comprising:
exciting the second Coriolis element with the aid of the second excitation element into an excitation oscillation substantially along a substantially closed circular trajectory located substantially parallel to the principal extension plane and substantially counter-clockwise around an axis parallel to the first axis when looking onto the principal extension plane, to cause the second Coriolis element to continuously exhibit motion states deflected with respect to a rest position, wherein a velocity vector of a mass center point of the second Coriolis element has, in each of the deflected motion states, an absolute value from greater than or equal to 90% of a predefined target velocity to less than or equal to 110% of the predefined target velocity, wherein a coupling structure couples the second Coriolis element to the first Coriolis element.
